(19) United States
(12) Patent Application Publication
(10) Pub. No.: US 2013/0319659 A1
(43) Pub. Date: Dec. 5, 2013

(54) Open-Hole Logging Instrument And Method For Making Ultra-Deep Magnetic And Resistivity Measurements

(71) Applicant: Robert Freedman, Houston, TX (US)

(72) Inventor: Robert Freedman, Houston, TX (US)

(73) Assignee: Schlumberger Technology Corporation, Sugar Land, TX (US)

(21) Appl. No.: 13/885,471

(22) PCT Filed: Nov. 15, 2011
(86) PCT No.: PCT/US11/60802

§ 371 Date: Aug. 24, 2013

Related U.S. Application Data
(60) Provisional application No. 61/415,414, filed on Nov. 19, 2010.

(51) Int. Cl. G01V 3/26

(52) U.S. Cl. CPC G01V 3/26
USPC 166/250.01; 324/346

(57) ABSTRACT

Methods and systems are provided for obtaining both magnetic and apparent resistivity ultra-deep reading electromagnetic measurements at the same time and/or by a single tool. The system can include a magnetometer, a current source electrode, a pair of voltage measuring electrodes, and a current return electrode. Using such a system can enable a lowering a tool into a relief well and obtaining both magnetic and apparent resistivity ultra-deep reading electromagnetic measurements in a single trip in order to provide a more accurate and faster determination of the distance and direction to a cased blown out well in order to shorten the time required to intersect and kill the blown out well.

### BACKGROUND OF THE INVENTION

1. Field of the Invention

The invention relates generally to the field of relief wells. More specifically, the invention relates to systems and methods for determining more accurate distance and direction measurements from an open relief well to a cased, blown-out well.

2. Background Art

Well blowouts, such as the BP Macondo well blowout in the Gulf of Mexico on Apr. 20, 2010, highlight both the need and the public expectation for the oil and gas industry to have available the most accurate and efficient tools possible for killing a blown out well. One of the tools of last resort is the drilling of a relief well. The objective of a relief well may be to intersect and penetrate the casing in the blown out well so that high density fluid (e.g., “heavy” drilling mud) can be pumped into the relief well and ultimately into the blown out well in order to “kill” the blown out well, i.e. to stop entry into the blow out well of fluids from formations penetrated by the blown out well. In cases where intersection of the relief well and the blown out well is not required, it may be necessary to bring the two wellbores into close proximity to one another for the same purpose, i.e., to pump fluid into the relief well and then into the blow out well to kill the blown out well.

The geodetic location the bottom of a well (“bottom hole location”) drilled through subsurface formations can have an ellipse of uncertainty whose axes can be of the order of 200 feet or more depending on the well axial length (depth) and other circumstances. The positional uncertainty is caused by small systematic and random errors in directional survey measurements that accumulate with increasing depth. For this reason the intersection of a small (e.g., 7 inch) diameter casing by a relief well at a depth of several miles below the water bottom or the Earth's surface is difficult given the uncertainties in the bottom hole locations of both wells. Therefore a ranging method is needed that can guide the relief well to the blown out well. The ranging method involves making deep reading logging measurements in the relief well that are sensitive to the presence of a pipe in a blown out well, e.g., casing or drill pipe. The ranging measurements are processed to estimate the distance and direction from the relief well to the blown out well.

In order for the ranging method to be effective in locating the blown out well, sensors disposed in the relief well ideally have sensitivity to the presence of the casing or drill pipe in the blown out well at distances of the order of 200 feet or more. For electromagnetic sensors such sensitivity requires the use of low frequency electromagnetic field of the order of 1 Hz or less and long spacings between an electromagnetic field source and electromagnetic field detectors. Such electromagnetic measurements are sensitive to the presence of the casing or drill pipe because the electrical conductivity of such pipe, typically made from electrically conductive material such as steel or various alloys thereof is typically more than six orders of magnitude greater than that of subsurface formations.

A magnetic ranging tool was developed at Cornell University and is known in the industry as Extended Lateral Range Electrical Conductivity (“ELREC”). A resistivity ranging tool and method developed by Schlumberger Well Surveying Corp., a predecessor to the assignee of the present invention, is known as the Ultra-Long Spaced Electrical Log (ULSEL).

The ULSEL tool is a very long spaced version of the Schlumberger Electrical Survey (ES) tool first developed by Marcel and Conrad Schlumberger in the 1920s. The ES tools were used to record the first Schlumberger resistivity log in 1927 in Pechelbron, France. ES tools had current and voltage measuring electrodes mounted on an insulated bridle or cable that was lowered into the well at the end of an electrical cable connected to an electric current source disposed at the surface. Referring to FIG. 1, the electric current electrodes are denoted by A as a current source electrode disposed in a well 12 and B as the current return electrode disposed at the surface and electrically coupled to the formations proximate the surface. Mounted between the A and B electrodes on the bridle 12 are pairs of voltage measuring electrodes denoted by “M” and “N”. A low frequency (e.g., approximately 1 Hertz or less) current (I) is imparted into the well from the A electrode, is returned to the surface at the B electrode and potential differences between one or more pairs of M and N electrodes are measured.

Apparent formation resistivities may be computed from the measured potential differences using pairs of voltage measuring electrodes M, N with different spacings therebetween. ES tools include a 16-inch “Normal” electrode pair whose electrode spacings are AM=16 in. (1.33 ft), AN=20 ft, AB=89 ft, and a 64-inch “Normal” with spacings, AM=64 in. (5.33 ft), AN=71 ft, and AB=89 ft. The depth of investigation (measurement extent laterally from the axis of the well) of ES tools is determined principally by the AM spacing. Because the A electrode emits a current that is unfocused, in conductive wells, i.e., those having electrically conductive fluid therein, the apparent resistivities from the short spaced ES measurements may be dominated by effects of such fluid in the well. The borehole effect on the ES tools was later addressed by the introduction of resistivity tools with focused current source electrodes, e.g., the Schlumberger “LATEROLOG 7” and its successors. The borehole effect on the longer spaced ULSEL measurements (e.g., 64 inch Normal) is substantially lower, or may even be negligible because of the longer distances between the M and N electrodes and the A electrode.

ULSEL tools were developed more than 40 years ago for determining distance from a well to a salt dome hydrocarbon trap in formations found in and near the Gulf Coast of the United States. ULSEL tools are essentially log-spaced ES tools consisting of current and voltage measuring electrodes on an insulated bridle. For salt dome profiling the bridle is about 5000 feet long and long spacings, e.g., AM=1000 feet and AN=4000 feet were able to detect salt domes at distances of 1200 to 1500 feet from an open well. For operation using very longest ULSEL spacings, very low frequencies are used to mitigate the skin-effect, which suppresses the measured apparent resistivities. Very long spaced normal and/or lateral measurements typically must be performed while the tool is stationary in the well.

The procedure used was to drill a well close to the salt dome to ensure efficient draining of the reservoir near the salt-dome flank. One of the major users and proponents of this technology for salt dome proximity logging was Standard Oil Company of California (now Chevron Corp.) which used ULSEL tools in wells drilled in shallow waters off the coast of Louisiana (see, e.g., R. J. Runge, A. E. Worthington, and D. R. Lucas, Ultra-Long Spaced Electric Log (ULSEL), SPWLA, 10th Annual Logging Symposium, 1969, Paper H). In the case of salt dome profiling, the ULSEL tool response is sensitive to the presence of salt domes because they have resistivities that are typically tens of thousands of ohm-meters and therefore represent a resistive anomaly (the opposite of a well casing which represents a conductive anomaly). Such anomaly is observable as an increase in the measured apparent ULSEL resistivity.

It was recognized that the ULSEL tool could also be used to detect conductive casing or drill pipe in a blown out well from within an open relief well. In 1972 Shell Oil Company used the ULSEL tool to estimate distance from relief wells to two blowouts (see, e.g., F. R. Mitchell, et al., “Using Resistivity Measurements to Determine Distance Between Wells,” J. Pet. Technology, pp. 723-740, June, 1972). The blowouts were in a well known as the Cox No. 1, a gas well producing 40% H2S located in Piney Woods, Miss. and the Bay Marchand Platform B well blowout off the coast of Louisiana. Using the notation AM/AN for electrode spacings the ULSEL spacings used by Shell for detecting the casing included 20/71, 75/350, 150/350, 75/600, 150/600 with all spacings designated in feet. The ULSEL tool can be moved along the interior of the relief well at moderate speeds using the foregoing spacings. As shown in FIG. 1, the configuration used by Shell included that the “B” current return electrode was located proximate the surface. Shell also used a magnetometer borrowed from Mobil Research Company to measure the static magnetic field produced by remnant magnetization of the blown out well steel casing. The static magnetic field measurements were used to predict direction to the blown out well. The method used to interpret the ULSEL data in the Shell relief wells did not include account of the effects of differing resistivities of the various formation layers and assumed a straight relief well trajectory. The Shell method of interpretation of ULSEL logs did not provide directional information. A more accurate method was later developed (Freedman, U.S. Pat. No. 4,329,647) for using ULSEL, short range resistivity, and directional survey data to provide both direction and more accurate distances. The short range resistivity measurements are used to construct a layered model of the subsurface formations penetrated by the relief well. These data may be obtained from an induction logging instrument or a laterolog instrument operated in the relief well or from open-hole well log information obtained from the blown out well before the casing was inserted. Freedman showed that the ULSEL instruments also provide unique direction to the cased, blown out well provided that the relief well direction or azimuth over the logged interval is not straight, i.e., the well trajectory is curved. If the well is straight then the ULSEL provides a distance to the relief well, however, the direction is not defined.

FIG. 2 shows a schematic diagram of the above-described ELREC instrument, which was developed by applied physics professor Arthur Kuckes at Cornell University around 1980 (see, e.g. U.S. Pat. Nos. 4,700,142; 4,791,373; and 5,218 301) and was offered commercially by Gearhart Industries, Inc. The ELREC instrument 9 includes an insulated bridle 22 that may be extended into and withdrawn from an open well 12. A current source 10 may be disposed at the surface and interconnected between a current source electrode A on the bridle 22 and a current return electrode B disposed proximate the surface. A magnetometer or magnetometer set 23 may be disposed at the lower end of the bridle 22. The magnetometer 23 may detect a magnetic field induced by the electric current impressed across the electrodes A, B, so that a direction from the open well 12 to a cased well 24 may be determined.

The ELREC instrument was used by Shell Oil Company in drilling a relief well in 1982 (see, C. L. West, A. F. Kuckes, and H. J. Ritch, Successful ELREC Logging for Casing Proximity in an Offshore Louisiana Blowout, SPE paper 11996, presented at the SPE 58th Ann. Tech. Conf. & Exhibition, held in San Francisco, Calif., Oct. 5-8, 1983). In the foregoing offshore Louisiana blowout, both ELREC and ULSEL instruments were used to provide a more accurate assessment of the location of the blown out well relative to the relief well.

ELREC tools are based on the principle that a low frequency (e.g., 1 Hz) alternating current (AC) imparted into an open (i.e., uncased) relief well will seek a low impedance path and flow through the steel casing or drill pipe in the blown out well. The current flow in the target or blown out well produces a low frequency magnetic field whose amplitude and direction are measured by magnetometers on the instrument(s) disposed in the relief well. The direction and amplitude of the detected magnetic field can be used in conjunction with directional survey measurements to predict distance and direction to the target or blown out well. In ideal situations the direction of the detected AC magnetic field is perpendicular to a plane containing the blown out well and the relief well. The distance to the blown out well requires knowing the current distribution in the blown out well casing. Such current distribution may be computed by making some assumptions that are not necessarily valid. One of these assumptions is that the current is flowing in an infinitely long casing. This assumption neglects the casing end effects and can lead to errors in the distances computed form the magnetic method.

There continues to be a need for more accurate devices for determining distance and direction from a relief well to a blown out well to assist in efficient drilling of such relief wells.

### SUMMARY OF THE INVENTION

One aspect of the invention is a well logging apparatus. The well logging apparatus includes at least one current source, and disposed a current source electrode, a current return electrode, a first pair of voltage measuring electrodes for measuring a potential difference between the first pair of voltage measuring electrodes, and a magnetometer for measuring a static magnetic field produced by an alternating current flowing on a casing of a blown out well.

Another aspect of the invention is a method for well logging. The method can include the steps of lowering into a wellbore a well logging apparatus including a current source electrode, a first pair of voltage measuring electrodes, and a magnetometer. A current is emitted from the current source electrode. A potential difference is measured across the first pair of voltage measuring electrodes. A low frequency magnetic field produced by an alternating current flowing on casing in a cased well is measured.

Other aspects and advantages of the invention will be apparent from the following description and the appended claims.

### BRIEF DESCRIPTION OF THE DRAWINGS

FIG. 1 is a schematic diagram of an ULSEL instrument showing a single pair of voltage measuring electrodes.

FIG. 2 is a schematic diagram of an ELREC instrument.

FIG. 3 is a schematic diagram of a well logging instrument according to an exemplary embodiment of the invention.

FIG. 4 shows an example of a combined magnetometer/accelerometer set in a housing disposed at the end of the bridle.

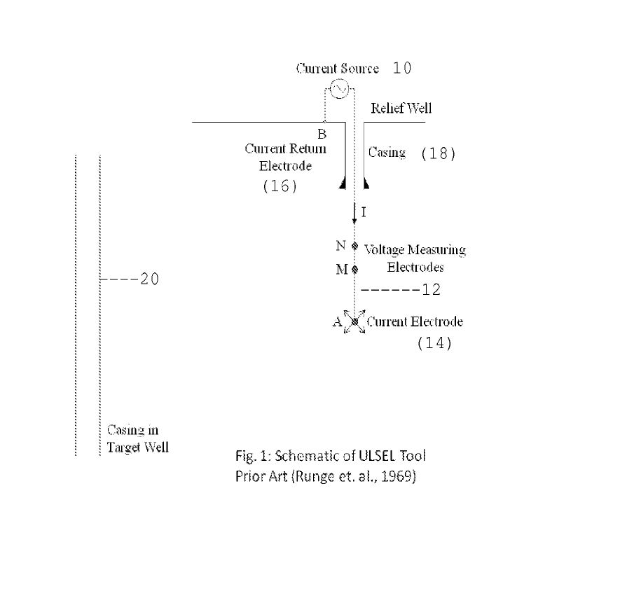

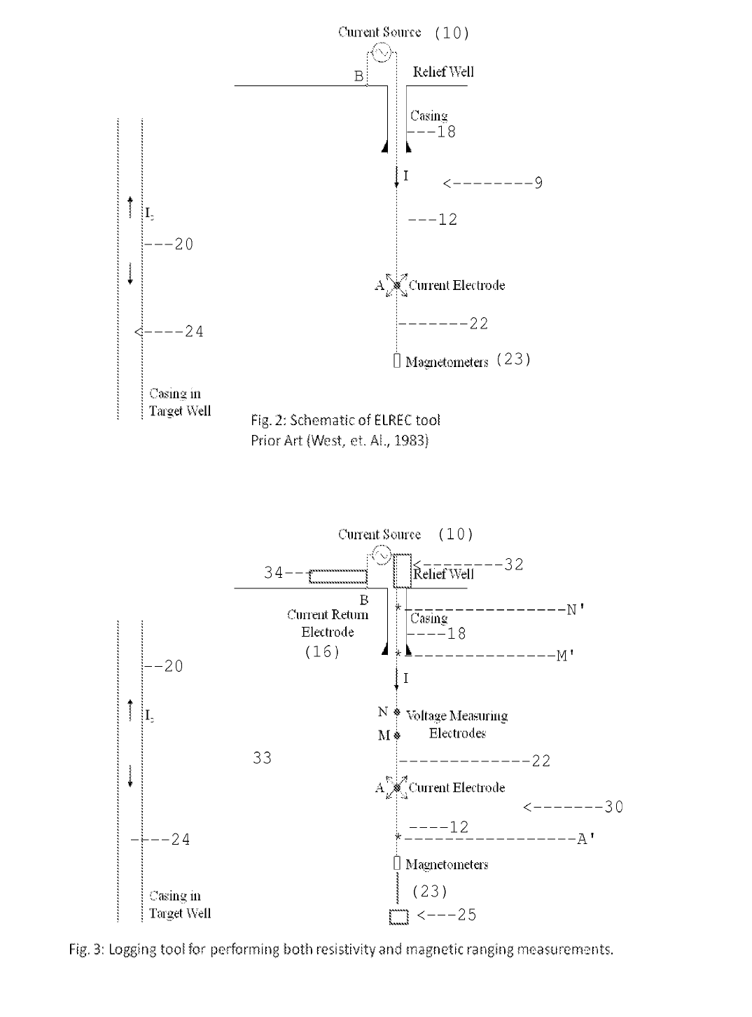

### DETAILED DESCRIPTION

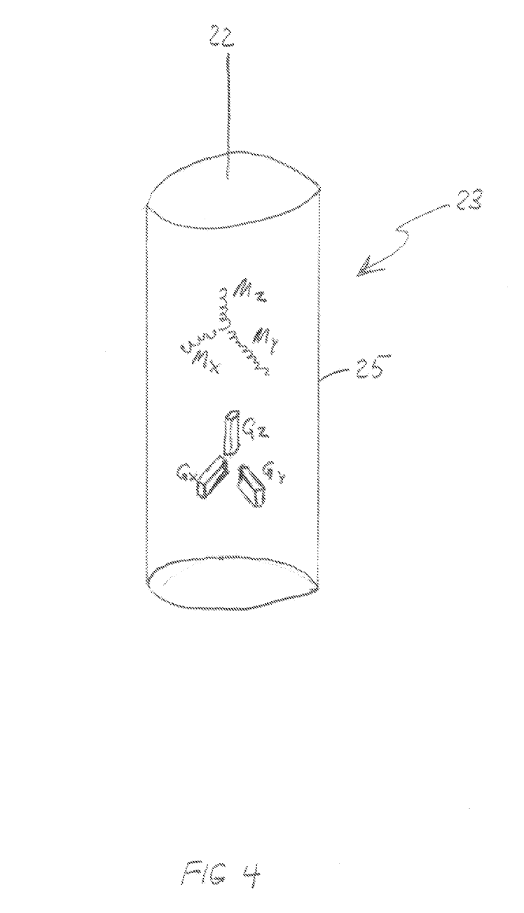

The invention provides for obtaining both magnetic field measurements and apparent resistivity electromagnetic measurements at the same time and/or by a single instrument. Methods and apparatus for performing such measurements will now be described with reference to FIG. 3, which depicts representative or illustrative embodiments of the invention.

FIG. 3 is a schematic illustration of an example well logging instrument 30 according to the invention. The instrument 30 may include a current source electrode A disposed on an insulated armored electrical cable (e.g., a bridle) 22 deployed in an open well 12. The instrument 30 may include one or more pairs of voltage difference measuring electrodes M, N disposed on the bridle 22 between a current source electrode A disposed on the bridle 22 and a source of electric current 10 disposed at the surface. The bridle 22 may be extended into and withdrawn from an open well 12 using a winch 32 or similar spooling device known in the art. Measurements of voltage drop across the voltage difference measuring electrodes M, N may be made in a recording unit 34 or similar device known in the art and disposed at the surface. The recording unit 34 may also include a processor or computer (not shown separately) of any type known in the art used in a well location recording unit. Such processor may make depth and/or time indexed recordings of the voltage drop measurements and magnetic field measurements and may include programming instructions to compute distance and direction from the open well to the cased well 24 using the foregoing measurements. A current return electrode B is shown in electrical contact with the formations proximate the surface. In FIG. 3 only a single pair of voltage measuring electrodes, M and N is shown, and the current return electrode B is disposed in the formations proximate the surface. In other examples there may be multiple pairs of voltage measuring electrodes disposed at various longitudinal distances along the bridle 12 from the current electrode A in order to provide sensitivity to a casing 20 in a cased well 24 over a range of lateral distances between the open well 12 and a cased well 24 in which the casing 20 is disposed. An example of such current source electrode is shown at A′ and corresponding voltage drop or potential difference measurement electrodes are shown at M′ and N′. It is to be also understood that in practice it may be preferable to have more than one current source electrode on the bridle 22, an example of which is shown at A. Likewise, the current return electrode B can either be located proximate the surface or in the open well 22. Locating the current return electrode B on the bridle may reduce the “Groeningen Effect” in circumstanced where one or more of the formation layers above the position of the current source electrode A is substantially electrically non-conductive (e.g., a non-porous carbonate rock layer or a salt layer).

A magnetometer assembly, shown in FIG. 3 at 23, may measure a directional component of a low frequency magnetic field. The low frequency magnetic field is induced by alternating current (Ic) flowing on the casing 20 in the cased well 24 as a result of the electromagnetic field induced by imparting low frequency AC across the current source A and current return B electrodes. The magnetometer assembly 23 in the instrument 30 can also include one or more magnetometers to measure a static magnetic field produced by residual magnetization of the casing 20 in the cased well. The static magnetic field has a generally short detectable range (i.e., about 15 feet) and is strongest near connections between segments (“joints”) of the casing 20, because such connections typically include internally threaded “collars” to connect the joints of casing 20 end to end whereby the metal thickness proximate the collars is greater than elsewhere along the casing 20. Some examples of the instrument 30 may include any type of gyroscope (not shown in FIG. 3) to determine the orientation of the instrument 30 with respect to a selected geodetic direction, typically geodetic north.

It should be understood that the relative locations of the magnetometer assembly 23 and the electrodes A, B, N, M shown in FIG. 3 are only one example of relative locations therefor. In other examples the magnetometer assembly 23 can be located above the current source electrode A. It may also be advantageous when non-conductive fluid is used in the open wellbore 12 to attach the current source electrode A and the voltage measuring electrodes M, N to a caliper or other pad-like device that is biased outwardly from the bridle 22 to make contact with the wall of the open well 12. The foregoing may ensure good electrical contact between the various electrodes A, M, N on the instrument 30 and the formations 33 in the subsurface.

There may be advantages to having both magnetic and apparent resistivity ultra-deep reading electromagnetic measurements (e.g., hundreds of feet) performed by a single tool. One important objective, but not the only objective of using such an instrument is to determine both the direction and the distance from a relief well to a blown out well. Other objectives may be to simply determine distance between a well being drilled and another well for avoiding intersection or to assist in causing intersection, depending on the purpose for the wells. For purposes of the invention, the well being drilled in which there is no casing at or near the depth of drilling will be referred to as the “open well”, while the other well, in which a casing is disposed at the target geodetic location and depth will be referred to as the “cased well.”

Determining both distance and direction from the open well 12 to the cased well 24 using electric and magnetic field measurements may include modeling the two types of sensor responses. Such modeling may be performed by solving Poisson's or Maxwell's equations for a current source (I) disposed in a layered subsurface medium containing a casing such as the one shown at 20. Each of the foregoing methods has certain advantages and disadvantages depending on the subsurface environment such that having both measurements available improves the accuracy of the predicted position of the cased well 24.

Apparent resistivity logs can be interpreted to predict distances from the open well 12 to the casing 24 in a cased well provided that an accurate model of the layers of the subsurface formations is used in the solution of Poisson's equation. The foregoing method can also provide a direction from the open well to the cased well provided that the open well trajectory is curved (see, e.g, Freedman, U.S. Pat. No. 4,329,647; and, Leonard, J. Production Editor, New method helps to find both distance and direction from relief well to blowout, Oil & Gas Journal, May, 17, 1982, p. 103-106). If the open well trajectory is straight over the interval in which voltage drop (potential difference) measurements are made then the apparent resistivity values calculated from the voltage drop measurements can be interpreted to provide only distance to the cased well. In the latter case measurements of the magnetic field direction made by the magnetometer assembly 23 can be interpreted to provide the direction from the open well to the cased well. Therefore having both measurements can provide both distance and direction. A model of the formation layers may be obtained from, for example, interpreted surface reflection seismic data, well log data (e.g., from the cased well prior to insertion of the casing 20 or from another nearby well), core sample data and/or combinations of the foregoing.

In general, distance predictions made from apparent resistivity measurement interpretation are more accurate than those obtained from the magnetic field amplitudes. The amplitude of the magnetic field measured by the magnetometer assembly 23 depends on the current distribution in the cased well 20. The actual current distribution in the cased well may be difficult to compute accurately. For example, in many situations the casing in a blown out well is ruptured. In such cases the assumption typically made that the casing 20 is an infinitely long current source is not valid. Furthermore, some of the current can return in the open well can be through the surface or other casing 18 in the open well 12 rather than entirely through the B electrode. Such current return is not accounted for in the computations of the current flowing in the cased well casing 20.

Moreover, the magnetometer assembly measurements may benefit from being centralized in the open well 12 so that the detected magnetic field is due entirely to current flow in the casing 20. Good centralization can be difficult to achieve in practice, especially in highly inclined wells. Eccentering of the magnetometer assembly 23 can be a source of uncertainty in determining the distance and direction from the magnetometer assembly measurements. For the foregoing reasons, the apparent resistivity measurements using a long spaced (example spacings are described in the Background section herein) electric logging instrument may be included to predict accurate distances to the cased well 24.

Another limitation of the magnetic field amplitude measurement method for determining distance between the open well and the cased well is that the magnetic field measurements are sensitive to motion of the magnetometer assembly 23. As will be appreciated by those skilled in the art, motion of the instrument 30 in the Earth's magnetic field and/or the electromagnetic field induced by imparting AC across the current source and return electrodes A, B, respectively, may induce voltages in the magnetometer assembly by the Lorenz force. Such sensitivity requires the magnetometer assembly 23 to be stationary during the measurements. Apparent resistivity measurements with respect to depth (“logs”) such as may be made using the instrument 30 can be recorded while the instrument is moving in the open well 12 thus providing continuous resistivity measurements along the open well 12 for analysis of the distance of the cased well 24 from the open well 20. Having both voltage drop measurements and magnetic field measurements, it is possible to make a few stationary measurements of the magnetic field amplitude using the magnetometer assembly 23 to predict the direction from the open well 12 to the cased well 24. The foregoing direction determination can be cross-checked with a direction predicted from the apparent resistivity measurements to provide a self-consistent check on the predicted cased well 24 direction from the open well 12.

The electrodes and magnetometer(s) shown in FIG. 3 may be attached to an insulated cable 12 that can be deployed with sinker weights 25 or other devices in order to be able deploy the instrument 30 in highly inclined wells. A desirable technique for deployment would be to dispose the foregoing electrodes A, N, M and magnetometer assembly 23 on a logging while drilling (“LWD”) instrument (not shown), however, such deployment would require an electrically non-conductive drill string. Otherwise the electric current from the source 10 would return substantially entirely on the drill string in the open well 12.

The magnetic field measurements made by the magnetometer assembly 23 are affected by the position of the magnetometer assembly 23 with respect to the center of the open well 12, as stated above. Therefore, it is desirable to use centralizers (not shown) to center the magnetometer assembly 23 in the open well 12.

Referring to FIG. 4, an example implementation of the magnetometer assembly is shown. Accelerometers, e.g., three mutually orthogonally disposed accelerometers Gx, Gy, Gz, may be disposed along with three mutually orthogonal magnetometers Mx, My, Mz disposed in a pressure resistant, non magnetic housing 25. The accelerometers may be used to monitor acceleration and displacement of the magnetometer assembly 23 for quality control and for correction of the data. By having mutually orthogonal or other directionally displaced measurements of the induced magnetic field using an assembly such as shown in FIG. 4, it may be possible to determine direction to the cased well (24 in FIG. 3) from the open well (12 in FIG. 3) using the three component magnetic field amplitude measurements made by the magnetometers Mx, My, Mz. How to perform such direction determination is well known in the art. See, e.g., U.S. Pat. No. 5,321,893 issued to Engebretson.

Referring once again to FIG. 3, during well logging operations, the instrument 30 is preferably operated in continuous depth logging mode, that is, the instrument 30 is lowered into or is withdrawn from the open well 12 substantially continuously and at a relatively constant speed, and continuous measurements of voltage drop (potential difference) are made with respect to depth in the open well 12. The measurement depths may be referenced to the depth position of the current source electrode A or other convenient depth reference. During operation of the instrument 30, current is emitted from the A electrode and potential differences from various pairs of M and N electrodes are measured. Simultaneously or sequentially the magnetic fields produced by the current induced in the casing 20 may also be measured. These data may be processed together with other data from the cased well 24, including directional survey and short ranged resistivity data (e.g. from an induction or laterolog instrument made prior to inserting the casing 20 in the cased well 24) to obtain distance and direction from any point along the open well 12 to the cased well 24. In some examples, the instrument 30 may be stopped from time to time to make stationary magnetic field measurements.

In addition to relief well drilling to kill a blown out well, the instrument 30 can be used to prevent unintended intersections of wells. Such use may be, for example, in situations where multiple directional wells are drilled from a single surface location or in well-placement applications to achieve close proximity to another cased well. The instrument can also be used for detecting distance to a salt dome or other high resistivity anomaly in the subsurface.

Although specific embodiments of the invention have been described above in detail, the description is merely for purposes of illustration. Various modifications of, and equivalent steps corresponding to, the disclosed aspects of the example implementations, in addition to those described above, can be made by those skilled in the art without departing from the scope of the invention defined in the following claims, the scope of which is to be accorded the broadest interpretation so as to encompass such modifications and equivalent structures.

What is claimed is:

1. A well logging apparatus comprising:
a current source;
a current source electrode disposed on an electrically insulated cable and electrically connected to the current source;
a current return electrode electrically connected to the current source;
at least a first pair of voltage measuring electrodes disposed on the insulated cable at a selected distance from the current source electrode;
a voltage drop measurement device electrically connected between each of the first pair of voltage measuring electrodes; and
a magnetometer disposed at a selected position along the electrically insulated cable.

2. The apparatus of claim 1, wherein the magnetometer, the first pair of voltage measuring electrodes, and the current source electrode are disposed within an open well when the cable is extended therein.

3. The apparatus of claim 1, further comprising at least a second pair of voltage measuring electrodes for measuring a potential difference between the second pair of voltage measuring electrodes, the at least a second pair disposed at a different spacing from the current source electrode than the first pair.

4. The apparatus of claim 1, wherein the current source is located at a surface location.

5. The apparatus of claim 1, further comprising an accelerometer disposed in a housing for the magnetometer.

6. The apparatus of claim 1 wherein the magnetometer comprises three mutually orthogonal magnetometers.

7. The apparatus of claim 1 further comprising three mutually orthogonal accelerometers disposed in a housing coupled to the cable, the housing having the magnetometer therein.

8. The apparatus of claim 1 further comprising means for determining a distance between an open well and a cased well from measurements made of voltage drop across the first pair and measurements made of magnetic field made by the magnetometer.

9. The apparatus of claim 8 wherein the means for determining comprises a recording unit disposed at the surface.

10. The apparatus of claim 1 further comprising a sinker weight disposed at one end of the cable for extending the cable into inclined wells.

11. A method for logging a well, comprising the step:
lowering a well logging apparatus into a wellbore, the apparatus comprising a current source electrode, a first pair of voltage measuring electrodes, and a magnetometer;
emitting an electric current from the current source electrode;
measuring a potential difference across the first pair of voltage measuring electrodes; and
measuring a magnetic field produced by current flowing in a casing disposed in a cased well.

12. The method of claim 10, wherein sinker weights are lowered with the well logging apparatus.

13. The method of claim 10, wherein lowering the well logging apparatus into the wellbore comprises extending the apparatus from a winch.

14. The method of claim 10, wherein the magnetometer and the current source electrode are lowered into the wellbore simultaneously.

15. The method of claim 10, wherein the measuring a potential difference across the first pair of voltage measuring electrodes and the measuring a magnetic field are performed substantially simultaneously.

16. The method of claim 10, wherein the well logging apparatus is stopped at selected times to perform the measuring the magnetic field.

17. The method of claim 10 further comprising measuring a static magnetic field in the casing.

18. The method of claim 10 further comprising measuring acceleration of the well logging apparatus and correcting measurements of the magnetic field for effects of acceleration.
